(19) United States
(12) Patent Application Publication
(10) Pub. No.: US 2006/0150685 A1
(43) Pub. Date: Jul. 13, 2006

(54) Method for elongating and collapsing a blank made of quartz glass

(75) Inventor: Heinz Fabian, Grossostheim (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS TENEVO GMBH, HANAU (DE)

(21) Appl. No.: 10/559,481

(22) PCT Filed: Jun. 3, 2004
(86) PCT No.: PCT/EP04/05991

§ 371 Date: Dec. 5, 2005

(30) Foreign Application Priority Data
Jun. 4, 2003 (DE) 103 25 538.9

(51) Int. Cl. C03B 37/07; C03B 37/025

(52) U.S. Cl. 65/382; 65/412; 65/435

(57) ABSTRACT

The invention relates to a method for the production of an optical component made of quartz glass by elongating a coaxial array, comprising of a hollow quartz glass cylinder that has an inner bore hole and that has been mechanically machined to the end volume and a core rod arranged inside the inner bore hole, wherein the coaxial array is fed to a heat zone with a predetermined forward feed motion and is softened zonewise therein and the optical component is drawn from the softened area, wherein an annular gap between the core rod and the hollow cylinder is collapsed. The invention aims at providing an economical method by means of which an optical component can be produced and which is characterized by a low break rate when the fibers are drawn. Depending on the outer diameter of the hollow cylinder D [in mm], the forward feed motion V [in mm/min] is maintained within a range complying with the following calculation Vₘᵢₙ=3000×(2/D)² and Vₘₐₓ=16000×(2/D)².

The present invention relates to a method for producing an optical component of quartz glass by elongating a coaxial assembly, comprising a hollow cylinder of quartz glass which includes an inner bore and has been mechanically treated to a final dimension, and a core rod arranged inside the inner bore, the coaxial assembly being supplied at a predetermined feed rate to a heating zone and softened therein zonewise and the optical component being drawn off from the softened region, with an annular gap between core rod and hollow cylinder being collapsed.

Furthermore, the present invention relates to an optical component comprising a core and a jacket overcladding the core.

Preforms for optical fibers are normally produced by collapsing and elongating a coaxial assembly consisting of core rod and at least one jacket or cladding tube. It is also known that a jacket tube is collapsed onto a core rod during fiber drawing, the last-mentioned method being designated as “ODD (overclad-during-drawing) method”.

EP-A 598 349 describes a thick-walled quartz glass cylinder for producing a large-volume preform for optical fibers. The thick-walled cylinder is collapsed onto a core rod during elongation. Said method is known under the name “RIC (rod-in-cylinder) method”. Several procedures are suggested for producing the quartz glass cylinder. In one procedure, a cylindrical quartz glass blank is provided that is either mechanically drilled using a core drill or is subjected to a hot upsetting method to produce a bore. In the second procedure, porous silicic-acid soot is deposited on a heat-resistant carrier according to the known OVD method, the carrier is then removed, and the soot body obtained thereby is dehydrated and vitrified.

A method and an optical fiber of the above-mentioned type are known from DE 102 14 029 A1. The publication describes a method in which a tube of synthetic quartz glass is first manufactured by producing a soot body by flame hydrolysis of SiCl₄ and vitrifying said soot body into a quartz glass block and by subsequently drilling the quartz glass block by means of a core drill. For a precise finishing operation of the tube obtained in this way it is suggested that the inner wall thereof should be re-worked by means of a honing machine and should be polished in a final step using an abrasive of the fineness grade # 800. To reduce surface tensions and to eliminate damage caused by surface treatment, the treated tube is etched in hydrofluoric acid.

Moreover, a so-called core rod is produced which consists of a core area of SiO₂ which is doped with germanium dioxide and has a cladding area surrounding the core area, which consists of undoped SiO₂.

For producing an optical fiber the core glass rod is inserted into the inner bore of the hollow cylinder of quartz glass and fixed therein with formation of a coaxial assembly. Starting with its lower end, said assembly is supplied from above to an electrically heated fiber drawing furnace at a predetermined feed speed and is heated therein to a temperature around 2180° C. and softened zonewise in this process. An optical fiber having an outer diameter of 125 μm is drawn off from the softened region at a predetermined drawing speed. During softening of the composite assembly consisting of hollow cylinder of quartz glass and core rod in the furnace, the annular gap between the core rod and the hollow cylinder of quartz glass is closed, with a negative pressure being maintained in the gap.

U.S. Pat. No. 4,820,322 A discloses a similar method for producing an optical fiber and for overcladding a core rod with a jacket or cladding tube with elongation of a corresponding coaxial assembly. A core rod and a cladding glass tube with predetermined optical properties and geometrical dimensions are provided and the core rod is arranged in the inner bore of the cladding tube: the remaining annular gap should here be kept as small as possible. Subsequently, said composite of core rod and cladding tube is zonewise softened in an annular heating element, a negative pressure being maintained in the annular gap. For economic reasons a collapsing operation that is as rapid as possible is desired, and values around 7 cm/min should here be achievable due to the negative pressure.

It has been found that the preforms produced according to the known methods often include bubbles on the boundary surface between core rod and hollow cylinder. The fibers that have been drawn from such preforms often show a poor quality. Particular attention is here paid to elongated bubbles along the boundary surface between core and jacket. These may result in low fiber strength and may particularly cause problems during splicing of the fibers.

It is an object of the present invention to provide an economic method by means of which an optical component can be produced by collapsing and elongating a coaxial assembly consisting of hollow cylinder and core rod, the optical component being distinguished by a low fracture rate during fiber drawing.

It is also the object of the present invention to provide a high-quality optical component produced according to the method, particularly with a defect-free boundary surface between core rod and hollow cylinder.

As for the method, this object is achieved according to the invention in that, depending on the outer diameter of the hollow cylinder D [in mm], the feed rate V [in mm/min] is kept within a range satisfying the following dimensioning rule
Vₘᵢₙ=3000×(2/D)² and
Vₘₐₓ=16000×(2/D)²

The result of the RIC method is an optical component in the form of a fiber or a preform in which the initially existing annular gap is collapsed and closed. The feed rate (also called “feed speed” in the following) defines the speed of the collapsing process. It has been found that particularly in the rapid collapsing processes, which are often desired for economic reasons, the boundary surface between hollow cylinder and core glass rod shows a poor quality. Therefore, according to the invention the feed speed during collapsing and elongating of the coaxial assembly has been chosen to be appropriately slow. This enables the inner surface of the hollow cylinder to melt to an adequate degree prior to impingement on the core rod. The surface of the hollow cylinder which has been mechanically treated to a final dimension is thereby made smooth. On the other hand, not only profitability studies speak against a slow performance of the collapsing operation, but it has also been found that a long-lasting collapsing process may cause deformations of core rod and hollow cylinder and thus geometry errors of the component produced therefrom.

Therefore, the useful range indicated on the basis of the above dimensioning rule for the feed rate is distinguished on the one hand by a lower limit (minimum feed rate Vₘᵢₙ) below which a distinct plastic deformation of the assembly is observed due to an excessively slow collapsing process and on the other hand by an upper limit (maximum feed rate Vₘₐₓ) which is low enough to ensure an adequate fusion of the inner wall of the hollow cylinder in dependence upon the outer diameter of the hollow cylinder, and which has a feed speed which is particularly slow in comparison with the prior art.

The requirement regarding a feed speed that is as low as possible is due to the mechanical finishing treatment of the hollow cylinder, as shall be explained in more detail hereinafter:

So far it has been assumed that a decisive criterion for the suitability of a hollow cylinder for use in an RIC method is the surface roughness thereof in the area of the inner wall. Therefore, the result of the mechanical treatment of the hollow cylinder has often been described with the help of roughness values, for instance in EP 0 309 027 A1, wherein the production of a quartz glass cylinder is described for use in a large-volume preform for the production of an optical monomode fiber.

However, it has been found that such a view only describes the actual facts in an inadequate manner. Preforms produced according to the RIC method will show the above-mentioned bubbles on the boundary surface between core rod and hollow cylinder even if a hollow cylinder is used showing particularly low roughness values. A distinct correlation between the roughness of the inner wall of the hollow cylinder and the quality of the resulting boundary surface in a preform obtained according to the RIC method or of the quality of the fiber drawn therefrom could not be detected.

With a mechanical treatment (particularly drilling, honing and grinding), a quartz glass blank having an outer diameter of more than 100 mm and a length of 2 m and more can be produced, using known honing and grinding methods and commercial apparatus suited therefor, completely in a straight cylinder with an exact circular cross-section and a small dimensional deviation, in the range of 1/100 mm. Detailed analyses, however, have shown that due to the mechanical treatment of the hollow cylinder in the near-surface area cracks (subsurface cracks) are bound to be formed that are closed and cannot be detected with standard roughness measurement methods. According to the prior art the hollow cylinder is cleaned with fluoric acid directly before use, with the subsurface cracks being opened. These cracks that are enlarged by acid cleaning may lead to defects in the area of the boundary surface between core rod and hollow cylinder in the subsequent collapsing process.

The depth of such cracks is surprisingly large even in cases where the damage layer produced by the preceding removal process is successively reduced in size in subsequent treatment steps and small forces act on the surface in the last treatment steps and a small removal rate is set.

Such surface defects of the mechanically treated hollow cylinder are eliminated in the method of the invention in that the feed rate is set according to the above dimensioning rule to a value below the indicated maximum feed speed Vₘₐₓ. This ensures that the mechanically treated surface has enough time for fusion, so that the existing cracks can be closed.

The feed rate suited for the fusion of the inner surface of the hollow cylinder depends on the wall thickness of the hollow cylinder and on the volume to be thoroughly heated on the whole, which volume in radial cross-section is composed of the core rod plus the wall of the hollow cylinder. In the above formula in which the suitable range for the feed rate is determined in a first approximation on the basis of the outer diameter of the hollow cylinder, the annular gap remaining between the core rod and the hollow cylinder is neglected for the sake of simplicity. In consideration of the physical units the above dimensioning rule reads as follows:
Vₘᵢₙ [mm/min]=3000 [mm³/min]×(2/D)² [mm⁻²] and
Vₘₐₓ [mm/min]=16000 [mm³/min]×(2/D)² [mm⁻²]

These physical units also form the basis for the parameters of the equations cited hereinafter, even if these are omitted for the sake of simplicity.

If the feed rate is below the indicated minimum feed speed Vₘᵢₙ, this will lead to geometrical deformations that cannot be accepted.

A cylinder mechanically treated to the final dimension is within the meaning of this invention also a cylinder whose inner surface has been mechanically treated to the final dimension and which is optionally cleaned by way of a chemical treatment (by etching), for etching processes do not effect a change in the geometrical final shape of the hollow cylinder (e.g. a bending or an ovality in the cross-section).

The inventive method does not rule out that in addition to the hollow cylinder mechanically treated to the final dimension the core rod is overclad with further jacket tubes, these being preferably jacket tubes that have also been treated mechanically to the final dimension.

Advantageous developments of the invention become apparent from the subclaims.

According to the invention the feed rate is set to be as low as possible, but as high as required to prevent deformations of the hollow cylinder and the core rod. It has turned out to be particularly advantageous when the maximum feed rate Vₘₐₓ is set on the basis of the dimensioning rule:
Vₘₐₓ=8000×(2/D)²

In a particularly preferred variant of the method of the invention, a hollow cylinder is used having an outer diameter D of at least 150 mm, the feed rate being set to a value below 2.5 mm/min, preferably below 1.5 mm/min.

Since a large-volume hollow cylinder is used having an outer diameter of at least 150 mm, this will yield an advantage with respect to costs and an improvement of the dimensional stability. The cost advantage is based on the increased volume and the resulting increased preform or fiber length, so that an inexpensive mass production can be realized. The improvement regarding the dimensional stability is achieved due to the fact that during elongation deviations of the hollow cylinder from the ideal cylinder symmetry are scaled down true to scale to the lower component diameter, and are thus less noticed than in the case of a minor reduction that is true to scale. When such hollow cylinders are used, a precondition for a high-quality boundary surface between core rod and hollow cylinder is, however, that collapsing is carried out at a low feed rate of not more than 2.5 mm/min, preferably below 1.5 mm/min.

A variant of the method has turned out to be particularly useful in which the mechanical treatment of the hollow cylinder comprises a grinding of the inner wall of the inner bore and a subsequent etching treatment, wherein subsurface cracks remaining after grinding show a crack depth of not more than 2 mm.

The mechanical treatment of the inner wall of the inner bore by grinding (which includes honing) is bound to create cracks. The crack depth can be successively reduced by repeated grinding, honing and polishing steps, which requires a lot of time and a great amount of material. The method of the invention, however, tolerates such cracks, on condition that the crack depth is less than 2 mm, thereby permitting the use of hollow cylinders which thanks to a less expensive mechanical treatment of their inner wall can be produced at comparatively low costs.

As for the width of the annular gap between core rod and hollow cylinder, two different measures have turned out to be advantageous.

In a first variant of the method, the annular gap between core rod and hollow cylinder is greater than 2 mm on average, preferably greater than 5 mm.

A large annular gap width ensures that the surface of the collapsing hollow cylinder is fused to an adequate degree before contacting the outer wall of the core rod. With large gap widths, however, the core rod must be centered exactly in the hollow cylinder to avoid later core eccentricities in the fiber. In a second and equally advantageous variant of the method, the annular gap between core rod and hollow cylinder is smaller than 1 mm on average, preferably smaller than 0.7 mm.

During collapsing a small annular gap width causes a comparatively small material flow in radial direction, which makes it easer to observe a predetermined geometry with respect to the fiber core eccentricity. This variant of the method should be particularly preferred when high demands are made on the geometry of the component and when the cylinder surfaces only show small cracks that melt easily.

The method of the invention turns out to be particularly advantageous especially in thick-walled hollow cylinders, for the wall thickness of the hollow cylinder plays an important role with respect to adequate fusion. With an increasing wall thickness of the quartz glass cylinder, the feed rate to be set rather decreases than increases. For economic reasons a hollow cylinder is preferably used having an inner diameter of not more than 70 mm, preferably not more than 50 mm.

The larger the outer diameter of the hollow cylinder is and the smaller the inner diameter, the larger is the quartz glass volume provided by the hollow cylinder and the more advantageous is the effect the method has with respect to production costs based on the fiber kilometer and with respect to the dimensional stability of the fiber obtained therefrom.

The wall thickness of the hollow cylinder plays an important role with respect to deformation and economy of the method of the invention. Hollow cylinder and core rod are preferably used where the ratio CSA_{(C)}/CSA_{(R)} of the radial cross-sectional area CSA_{(C)} of the hollow cylinder and the radial cross-sectional area CSA_{(R)} of the core rod is within the range between 5 and 100, preferably between 10 and 80.

The larger the wall thickness of the hollow cylinder, the smaller is the deformation to be expected under otherwise identical collapsing conditions. A large wall thickness requires an enhanced “thorough heating” for ensuring an adequate fusion of the inner wall of the hollow cylinder. This is rather in support of a slow feed rate. The manufacturing accuracy for the optical component increases with an increasing wall thickness because absolute geometrical flaws (which are independent of the wall thickness and the outer diameter of the quartz glass cylinder) are scaled down more strongly during elongation.

It has turned out to be particularly advantageous to produce the hollow cylinder according to the so-called OVD method.

In this outside deposition method a tubular body is obtained which due to the production has an exact inner bore which after vitrification just requires a minor mechanical finishing treatment.

The invention shall now be described in more detail with reference to an embodiment and a patent drawing. As the sole FIGURE,

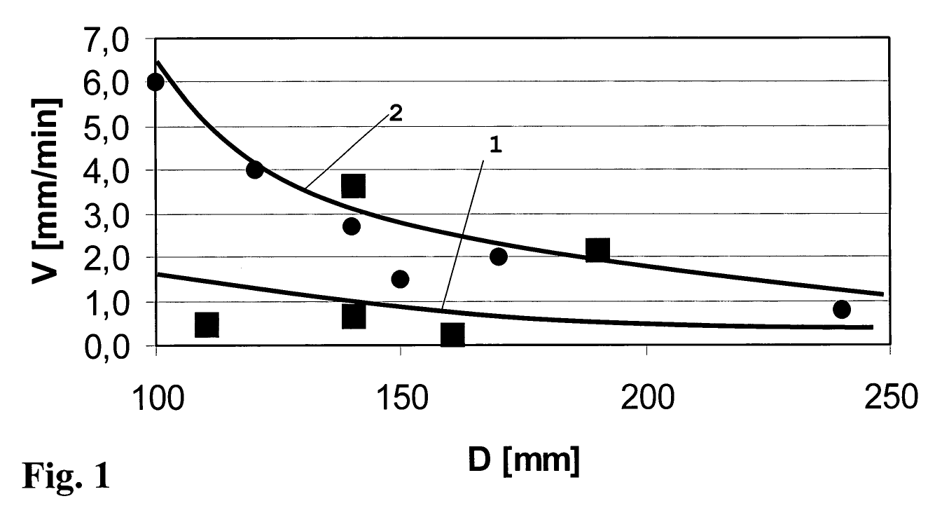

FIG. 1 shows a diagram with results of RIC tests using hollow cylinders with different outer diameters and at a varying feed rate.

In the tests described in the following, preforms and optical fibers were produced according to the RIC method by overcladding a core rod with a hollow cylinder of quartz glass and by elongating the composite assembly. The preforms and fibers have a core region which is surrounded by an inner cladding glass layer and an outer cladding glass layer. The core region consists of quartz glass homogeneously doped with 5% by wt. of germanium dioxide. The cladding glass layers consist of undoped quartz glass, of which part is provided by the jacket or cladding of the core rod and part by a mechanically treated hollow cylinder of quartz glass.

Production of Core Rods and Hollow Cylinders

The production of the core rods and the hollow cylinders of quartz glass shall now be explained in more detail in the following with reference to an embodiment:

The core rod was produced according to the OVD method by depositing soot particles in layers on a carrier rotating about its longitudinal axis by reciprocating a deposition burner, the deposition burner being fed with SiCl₄ and GeCl₄ and the soot particles being hydrolyzed in a burner flame in the presence of oxygen into SiO₂ and GeO₂. The ratio of SiCl₄ and GeCl₄ was adjusted during deposition of the inner layers such that a predetermined homogeneous GeO₂ concentration of 5% by wt. was obtained over this part of the wall thickness of the soot body. As soon as the soot layers had been deposited, with the soot layers forming the core region of the core rod, the supply of GeCl₄ to the deposition burner was stopped, and a first inner cladding glass layer of undoped SiO₂ was deposited on the core region.

After completion of the deposition method and removal of the carrier, a soot tube was obtained that was subjected to a dehydration treatment for removing the hydroxyl groups introduced due to the manufacturing process. To this end the soot tube was introduced in vertical orientation into a dehydration furnace and first treated at a temperature ranging from 850° C. to about 1000° C. in a chlorine-containing atmosphere. The treatment duration was about six hours. A hydroxyl group concentration of less than 100 wt ppb was thereby achieved.

The soot tube treated in this way was vitrified in a vitrification furnace at a temperature in the range around 1350° C. and the inner bore was collapsed in this process, resulting in a core rod having the desired refractive index profile.

The core rods were thereby produced with the dimensions as shown in Table 1, the respective core diameter being adapted to the associated hollow cylinders in such a manner that a central “core region” having a diameter of about 8.5 μm was each time obtained in the optical fiber at an outer diameter of 125 μm

By analogy with the above described production of the core rod, porous soot bodies were produced by outside deposition with the help of an OVD method, but without addition of a dopant. After removal of the carrier the soot tube was subjected to the above-described dehydration treatment and then vitrified. The two end regions of the tubular quartz glass blank, which was produced in this way and made from synthetic quartz glass, were cut off and the outer wall was coarsely ground by means of a peripheral grinder equipped with a #80 grinding stone, whereby the predetermined desired outer diameter was substantially obtained. The outer surface of the tube was then ground by means of an NC peripheral grinder. The inner bore of the tube obtained in this way was treated on the whole by means of a honing machine equipped with a #80 honing bar, the degree of polish being made continuously finer and the final treatment being carried out with a #800 honing bar. After it had been made sure that the tube was produced at a wall thickness within a predetermined tolerance range, it was etched in a 30% fluoric-acid etching solution for a short period of time. The maximum surface roughness Rₘₐₓ was then 3.5 μm in the area of the inner wall, and 77 μm in the area of the outer wall. The dimensions of the resulting hollow cylinders of synthetic quartz glass are also listed in Table 1.

The depth of the existing subsurface cracks was determined on a piece of the hollow cylinder in a separate test. To this end the tube piece was etched in 68% hydrofluoric acid for such a long period of time that the crack base could be detected optically or by means of a surface roughness measuring device. A maximum crack depth of about 0.5 mm was each time obtained from said measurements.

Production of the Optical Fibers by Means of the RIC Method

A core rod having the dimensions indicated in Table 1 was each time inserted into a hollow cylinder and fixed therein. The wall thickness of the hollow cylinder and, adapted thereto, the diameter of the core rod, the feed rate and the width of the annular gap between hollow cylinder and core rod were varied.

The composite consisting of hollow cylinder and core rod was then supplied to an electrically heated furnace at a predetermined feed speed (see Table 1) and heated therein zonewise to a temperature ranging from 2000° C. to 2400° C., an optical fiber being drawn from the softened region. The draw-off speed was each time adapted to the feed rate in such a manner that the desired fiber diameter of 125 μm±0.5 μm was obtained. The remaining process parameters, of which the drawing temperature should be specifically mentioned, were not changed. A vacuum ranging from 2 kPa to 10 kPA was each time maintained in the annular gap between core rod and hollow cylinder.

For producing an optical preform according to the above-explained method, the draw-off speed was adapted at the same feed rate to the feed rate such that a desired diameter of the preform of 85.0 mm+−0.5 mm was obtained.

Test Evaluation

The quality of the boundary surface between the core region of the fiber and the cladding glass obtained on account of the hollow cylinder were analyzed microscopically. Particular attention was paid to so-called elongated bubbles on the boundary surface.

Moreover, the cylinder symmetry of the preforms and fibers on radial cross-sections was checked by taking random samples.

The qualitative results obtained thereby are listed in the last two columns of Table 1, the symbol “++” standing for “very good”, “+” for “good” and “−” for poor.

TABLE 1

| | | | Core | Annular | Feed | Boun- | |
|---|---|---|---|---|---|---|---|
| | Hollow cylinder | | rod | gap | rate | dary | Cylinder |
| Test | Outer Φ | Inner Φ | Outer Φ | width | [mm/ | surface | sym- |
| No. | [mm] | [mm] | [mm] | [mm] | min] | quality | metry |
| 1 | 100 | 20 | 18 | 1.0 | 6.0 | + | ++ |
| 2 | 110 | 22 | 20 | 1.0 | 0.5 | ++ | − |
| 3 | 120 | 30 | 28 | 1.0 | 4.0 | + | + |
| 4 | 120 | 30 | 29 | 0.5 | 4.0 | + | ++ |
| 5 | 140 | 52 | 50 | 1.0 | 3.7 | − | ++ |
| 6 | 140 | 52 | 50 | 1.0 | 0.7 | ++ | + |
| 7 | 140 | 52 | 50 | 1.0 | 2.7 | + | + |
| 8 | 140 | 52 | 20 | 11.0 | 2.7 | ++ | + |
| 9 | 150 | 60 | 58 | 1.0 | 1.5 | + | + |
| 10 | 160 | 60 | 58 | 1.0 | 0.3 | ++ | − |
| 11 | 170 | 60 | 58 | 1.0 | 2.0 | + | + |
| 12 | 190 | 60 | 58 | 1.0 | 2.2 | − | ++ |
| 13 | 240 | 60 | 58 | 1.0 | 0.8 | + | + |

These results show that the surface defects of the hollow cylinder which are produced due to the mechanical treatment and which can at best be eliminated by taking efforts that cannot be defended economically can be neglected whenever the RIC process according to the invention is carried out at a particularly slow feed rate. How-ever, an extremely slow feed rate due to plastic deformation of hollow cylinder and core rod may also deteriorate the results.

The data shown in columns 2 and 6 of Table 1 are plotted in relation with each other in the diagram of FIG. 1, namely the feed rate in mm/min on the y-axis and the hollow cylinder diameter in mm on the x-axis. The tests which were rated good (+) both with respect to fiber geometry and with respect to quality are plotted in this diagram as circles, whereas the tests which show a negative result in one of said categories are represented by squares.

It follows from the above that unfavorable results were obtained both at a fast feed rate and at a slow feed rate. The best results were achieved when the feed rate (in dependence upon the hollow cylinder diameter) is within a range defined downwards by line 1 and upwards by line 2. Lines 1 and 2 can be described by the following equation:
Line 1=Vₘᵢₙ [mm/min]=3000 [mm³/min]×(2/D)² [mm⁻²] and
Line 2=Vₘₐₓ [mm/min]=16000 [mm³/min]×(2/D)² [mm⁻²]

The width of the annular gap between hollow cylinder and core rod in the RIC process has a less drastic effect. The general trend seems to be that a wide annular gap has an advantageous effect on the quality of the boundary surface, whereas a narrow annular gap promotes the dimensional stability of the preform and the fiber drawn therefrom.

1. A method for producing an optical component of quartz glass, the method comprising: elongating a coaxial assembly, the coaxial assembly comprising a hollow cylinder of quartz glass having an inner bore and an outer diameter, the hollow cylinder being mechanically treated to a final dimension, and a core rod arranged inside the inner bore, the coaxial assembly being supplied at a predetermined feed rate to a heating zone and being softened therein zonewise, and the optical component being drawn off from the softened region, an annular gap between the core rod and the hollow cylinder being collapsed, wherein the hollow cylinder has an outer diameter D of at least 150 mm, and the predetermined feed rate, V (expressed in units of mm/min), is kept within a range satisfying the following dimensioning rule:
Vₘᵢₙ=3000×(2/D)²,
Vₘₐₓ=16000×(2/D)²,
and wherein the predetermined feed rate is below 2.5 mm/min.

2. The method according to claim 1, wherein the predetermined feed rate is is kept below a Vₘₐₓ determined according to the expression 8000×(2/D)².

3. The method according to claim 1, wherein the predetermined feed rate is set to a value below 1.5 mm/min.

4. The method according to claim 1, wherein the mechanical treatment of the hollow cylinder includes grinding of the inner wall of the inner bore and a subsequent etching treatment, the inner wall of the inner bore having subsurface cracks that remain after grinding, the subsurface cracks having a crack depth ranging from 0.2 mm to 2 mm.

5. The method according to claim 1, wherein the annular gap between the core rod and the hollow cylinder is on average greater than 2 mm.

6. The method according to claim 1, wherein the annular gap between the core rod and the hollow cylinder is on average smaller than 1 mm.

7. The method according to claim 1, wherein the hollow cylinder has an inner diameter of not more than 70 mm.

8. The method according to claim 1, wherein a ratio of a radial cross-sectional area CSA_{(C)} of the hollow cylinder to a radial cross-sectional area CSA_{(R)} of the core rod is within the range between 5 and 100.

9. The method according to claim 1, wherein the hollow cylinder is produced by an OVD method.

10. The method according to claim 2, wherein the mechanical treatment of the hollow cylinder includes grinding of the inner wall of the inner bore and a subsequent etching treatment, the inner wall of the inner bore having subsurface cracks that remain after grinding, the subsurface cracks having a crack depth ranging from 0.2 mm to 2 mm.

11. The method according to claim 3, wherein the mechanical treatment of the hollow cylinder includes grinding of the inner wall of the inner bore and a subsequent etching treatment, the inner wall of the inner bore having subsurface cracks that remain after grinding, the subsurface cracks having a crack depth ranging from 0.2 mm to 2 mm.

12. The method according to claim 1, wherein the annular gap between the core rod and the hollow cylinder averages greater than 5 mm.

13. The method according to claim 1, wherein the annular gap between the core rod and the hollow cylinder is on average smaller than 0.7 mm.

14. The method according to claim 1, wherein the hollow cylinder has an inner diameter of not more than 50 mm.

15. The method according to claim 1, wherein a ratio of a radial cross-sectional area CSA_{(C)} of the hollow cylinder to a radial cross-sectional area CSA_{(R)} of the core rod is within the range between 10 and 80.

16. The method according to claim 2, wherein the annular gap between the core rod and the hollow cylinder averages greater than 5 mm.

17. The method according to claim 2, wherein the annular gap between the core rod and the hollow cylinder is on average smaller than 0.7 mm.

18. The method according to claim 2, wherein the hollow cylinder has an inner diameter of not more than 50 mm.

19. The method according to claim 2, wherein a ratio of a radial cross-sectional area CSA_{(C)} of the hollow cylinder to a radial cross-sectional area CSA_{(R)} of the core rod is within the range between 10 and 80.

20. The method according to claim 1, wherein wherein the mechanical treatment of the hollow cylinder includes grinding of the inner wall of the inner bore and a subsequent etching treatment, the inner wall of the inner bore having subsurface cracks that remain after grinding, the subsurface cracks having a crack depth ranging from 0.2 mm to 2 mm, wherein the annular gap between the core rod and the hollow cylinder averages greater than 5 mm, wherein the annular gap between the core rod and the hollow cylinder is on average smaller than 0.7 mm, and wherein the hollow cylinder has an inner diameter of not more than 50 mm.
